(19) United States
(12) Patent Application Publication
(10) Pub. No.: US 2009/0011332 A1
(43) Pub. Date: Jan. 8, 2009

(54) NEGATIVE ACTIVE MATERIAL FOR NICKEL-METAL HYDRIDE ACCUMULATOR

(75) Inventors: Celine LAVAUD, Bordeaux (FR); Valerie Dillay, Ludon Medoc (FR); Patrick Bernard, Bordeaux (FR)

Correspondence Address: SUGHRUE MION, PLLC, 2100 PENNSYLVANIA AVENUE, N.W., SUITE 800, WASHINGTON, DC, 20037, US

(73) Assignee: SAFT GROUPE SA, Bagnolet (FR)

(21) Appl. No.: 12/166,653

(22) Filed: Jul. 2, 2008

(30) Foreign Application Priority Data
Jul. 6, 2007 (FR) 07 04 895

(51) Int. Cl. H01M 4/38; C22C 28/00

(52) U.S. Cl. 429/218.2; 420/416

(57) ABSTRACT

The subject of the invention is a composition comprising:
a) a hydrogen-fixing alloy of formula ABₓ where:
A is an element chosen from the group comprising La, Ce, Nd, Pr and Mg, or a mixture of these;
B is an element chosen from the group comprising Ni, Mn, Fe, Al, Co, Cu, Zr, Sn, or a mixture of these;
x is from 3 to 6;
b) a magnesium compound in such a proportion that its mass is greater than 0.1% and less than or equal to 5% of the mass of the hydrogen-fixing alloy.

This composition can be used as an active material of a negative electrode of a nickel-metal hydride accumulator. Such an accumulator displays a reduced self-discharge. The invention also describes the method of producing such an accumulator.

### TECHNICAL FIELD

The technical field of the invention is that of nickel-metal hydride (NiMH) accumulators possessing a reduced self-discharge.

### STATE OF THE ART

An NiMH accumulator typically comprises at least one positive electrode (cathode) comprising an active material mainly constituted of nickel hydroxide Ni(OH)₂, at least one negative electrode (anode) mainly constituted of a metal capable of reversibly inserting hydrogen to form a hydride. The positive electrode is separated from the negative electrode by a separator which is generally constituted of polyolefin or polyamide. The electrochemical bundle constituted by the set of positive and negative electrodes and separators is impregnated with an electrolyte which is generally a strong base solution such as NaOH, LiOH or KOH.

One drawback of the NiMH accumulator is its high self-discharge. Self-discharge corresponds to a drop in the state of charge of the accumulator when this is in storage and no current is flowing through a current-consuming device. One of the causes of increased self-discharge is the existence of active electrochemical species in the electrolyte “shuttling” between the positive electrode and the negative electrode (“redox shuttle”). Nitrogen-containing impurities are the cause of the existence of these electrochemical shuttles. These impurities are oxidized at the charged positive electrode in order to form nitrate ions or nitrite ions. The nitrate (or nitrite) ions then travel across the separator and are reduced to ammonium hydroxide NH₄OH at the negative electrode. The ammonium hydroxide travels across the separator in the opposite direction and oxidizes at the positive electrode into nitrate (or in nitrite), which travels across the separator to the negative electrode and so forth.

To overcome this problem, technical solutions exist such as separators grafted by acrylic acid. Such separators are capable of quenching the ammonium hydroxide. In this respect, reference may be had to the article “Separators for nickel metal hydride and nickel cadmium batteries designed to reduced self-discharge rates” published in Journal of Power Sources 2004, 137(2), 317-321 which describes the application to a separator constituted of polyolefin fibres of a high-density polyethylene powder onto which acrylic acid has been grafted.

Another solution is to sulphonate the separator, i.e. substitute a hydrogen atom by a SO₃H group. The sulphonation allows the self-discharge of the accumulator to be reduced, while quenching the ammonium hydroxide. It also gives the surface of the separator a hydrophilic character necessary for a good wettability of the separator. Documents JP 01-132044, EP-A-1 047 140, JP 2001-283818, US 2002/0160260 and JP 2004-031293 describe a polyolefin separator the surface of which is sulphonated. The sulphonation process consists of immersing the separator in fuming sulphuric acid. It is necessary to leave the separator to impregnate in the sulphuric acid bath long enough for sulphonation to occur. The sulphonation stage is generally followed by an immersion of the sulphonic separator in baths of increasingly lower acid concentrations, then washing in water. The sulphonation produces sulphuric acid waste that needs to be treated. This technical solution is therefore not simple to implement.

Moreover, in certain NiMH accumulators, ability of the separator to quench the nitrogenous compounds can be less than the quantity of nitrogenous compounds present in the electrolyte. In these conditions, the self-discharge of these accumulators will be poor. Moreover, methods such as the grafting of acrylic acid or sulphonation lead to local variations in the capacity of the separator to quench the nitrogenous compounds, thus generating a variability in the self-discharge of the accumulator during its production on an industrial scale.

Another technical solution for reducing self-discharge is to add an additive having the property of quenching ammonium hydroxide to the accumulator. Document JP 2005-216676 describes the addition of particles of polymer possessing a carbodiimide monomer of formula —R—N═C═N—, in which R is an organic group. The additive particles can be deposited on the separator or dispersed in the electrolyte. The additive reduces the self-discharge by quenching the ammonium hydroxide.

Document JP 2001-023683 describes the addition of a polysulphonated product of a phenolic compound to the electrolyte of the accumulator.

Therefore a nickel-metal hydride accumulator possessing an increased capacity to quench the nitrogenous compounds is sought. A means of overcoming the problem of the dispersion of the capacity of the separators for quenching the nitrogenous compounds during production of an NiMH accumulator on an industrial scale is also sought.

None of the above documents teaches or describes the accumulator according to the invention.

### SUMMARY OF THE INVENTION

The subject of the invention is a composition comprising:

a) a hydrogen-fixing alloy of formula ABₓ where:

A is an element chosen from the group comprising La, Ce, Nd, Pr and Mg, or a mixture of these;

B is an element chosen from the group comprising Ni, Mn, Fe, Al, Co, Cu, Zr, Sn, or a mixture of these;

x is from 3 to 6;

b) a magnesium compound in such a proportion that its mass is greater than 0.1% and less than or equal to 5% of the mass of the hydrogen-fixing alloy.

This composition can be used as an active material of a negative electrode of a nickel-metal hydride accumulator.

According to an embodiment, the alloy is chosen from the group comprising alloys of the type AB₅, A₅B₁₉ and A₂B₇.

According to one embodiment, the mass of the magnesium compound is from 1 to 4% of the mass of the hydrogen-fixing alloy, preferably from 2 to 4% of the mass of the hydrogen-fixing alloy.

According to one embodiment, the magnesium compound is chosen from the group comprising Mg(OH)₂, MgSO₄, MgO and Mg₃(PO₄)₂.

According to one embodiment, the composition contains an yttrium compound.

Preferably, the yttrium mass represents from 0.1% to 2% of the mass of the hydrogen-fixing alloy, preferably more than 0.2% to 1% of mass of the hydrogen-fixing alloy.

A subject of the invention is also an electrode containing the composition according to the invention.

A subject of the invention is also an accumulator containing at least one electrode according to the invention. Such an accumulator displays a reduced self-discharge.

A subject of the invention is also a method of producing the electrode according to the invention. This production process comprises the stages:

a) providing a hydrogen-fixing alloy of formula ABₓ, where:

A is an element chosen from the group comprising La, Ce, Nd, Pr and Mg, or a mixture of these;

B is an element chosen from the group comprising Ni, Mn, Fe, Al, Co, Cu, Zr, Sn, or a mixture of these;

x is from 3 to 6;

b) providing a magnesium compound in such a proportion that its mass is greater than 0.1% and less than or equal to 5% of the mass of the hydrogen-fixing alloy;

c) preparing an aqueous mixture comprising the alloy and compound with the magnesium in order to form a paste;

d) depositing the paste obtained in stage c) on a support.

### DETAILED DESCRIPTION OF THE EMBODIMENTS OF THE INVENTION

The invention proposes a negative-electrode active-material composition for an alkaline nickel metal hydride accumulator, comprising:

a) a hydrogen-fixing alloy of formula ABₓ where:

A is an element chosen from the group comprising La, Ce, Nd, Pr and Mg, or a mixture of these;

B is an element chosen from the group comprising Ni, Mn, Fe, Al, Co, Cu, Zr, Sn, or a mixture of these;

x is from 3 to 6;

b) a magnesium compound in such a proportion that its mass is greater than 0.1% and less than or equal to 5% of the mass of the hydrogen-fixing alloy.

Preferably, the alloy is chosen from the group comprising alloys of the type AB₅, A₅B₁₉ and A₂B₇.

The magnesium compound can be chosen from Mg(OH)₂, MgSO₄, MgO and Mg₃(PO₄)₂.

In a preferred embodiment, the mass of the magnesium compound is from 1 to 4% of the mass of the hydrogen-fixing alloy, preferably from 2 to 4% of the mass of the hydrogen-fixing alloy.

Without wishing to be bound by the theory, the applicant is of the opinion that the effect of mixing the alloy with a magnesium compound is to quench some of the nitrogen present in the accumulator. When the quantity of this magnesium compound becomes too large in the negative electrode, the quantity of material not absorbing the hydrogen increases, which leads to a reduction of the negative excess and therefore to a shortened accumulator life. Thus, the proportion by mass of the magnesium compound in the negative electrode must be limited to 5% of the mass of hydrogen-fixing alloy.

The process of adding magnesium compound to the active material during the production of the anode is simple to implement industrially and consists of adding said product during the preparation of the paste which is to be coated on the electrode.

According to a preferred embodiment, an yttrium-based compound is also mixed into the composition of the invention. The yttrium-based compound is chosen from a non-exhaustive list comprising an yttrium-based oxide such as Y₂O₃, an yttrium-based hydroxide such as Y(OH)₃ or an yttrium-based salt. Preferably, the yttrium-based compound is yttrium oxide Y₂O₃. The yttrium-based compound is mixed with the alloy in a proportion such that the mass of yttrium represents from 0.1% to 2% of the mass of the alloy, preferably from 0.2% to 1% of the mass of the alloy. The effect of mixing the composition of the invention with an yttrium compound is to increase the cycle life of the negative electrode.

The invention also relates to an anode containing said active-material composition: The anode is produced by pasting a support with a paste constituted of an aqueous mixture of the active-material composition according to the invention and additives.

The support can be a nickel foam, a flat or three-dimensional perforated strip made of nickel or nickel-plated steel.

The additives are intended to ease the implementation or the performances of the anode. They can be thickening agents such as carboxymethylcellulose (CMC), hydroxypropylmethylcellulose (HPMC), poly(acrylic acid) (PAAc), poly(ethylene oxide) (PEO), xanthan gum. They can also be binders such as butadiene-styrene (SBR) copolymers, polystyrene acrylate (PSA), polytetrafluoroethylene (PTFE). They can also be polymer fibres, such as polyamide, polypropylene, polyethylene, etc. for improving the mechanical properties of the electrode. They can also be conductors such as nickel powder, carbon powder or fibres, nanotubes.

Advantageously, the anode is covered with a surface layer intended to improve the high-rate discharge and/or the recombination of the oxygen at the end of charging.

The invention also relates to an accumulator with an alkaline electrolyte, for example nickel-metal hydride, comprising at least one anode according to the invention. This accumulator typically comprises said at least one anode, at least one nickel cathode, at least one separator and an alkaline electrolyte.

The cathode is constituted of the cathodic active mass deposited on a support which can be a sintered support, a nickel foam, a flat or three-dimensional perforated strip made of nickel or nickel-plated steel.

The cathodic active mass comprises the cathodic active material and additives intended to ease its implementation or its performances. The cathodic active material is a nickel hydroxide Ni(OH)₂ which can be partially substituted by Co, Mg and Zn. This hydroxide can be partially oxidized and can be coated with a surface layer based on cobalt compounds.

Among the additives there can be mentioned, without this list being exhaustive, carboxymethylcellulose (CMC), hydroxypropylmethylcellulose (HPMC), hydroxypropylcellulose (HPC), hydroxyethylcellulose (HEC), xanthan gum, poly(acrylic acid) (PAAc), polystyrene maleic anhydride (SMA), butadiene-styrene (SBR) copolymers optionally carboxylated, an acrylonitrile and butadiene (NBR) copolymer, a styrene, ethylene, butylene and styrene (SEBS) copolymer, a styrene, butadiene and vinylpyridine (SBVR) terpolymer, polystyrene acrylate (PSA), polytetrafluoroethylene (PTFE), a fluorinated ethylene and propylene (FEP) copolymer, polyhexafluoropropylene (PPHF), ethylvinyl acetate (EVA), zinc oxide ZnO, fibres (Ni, C, polymers), powders of cobalt-based compounds such as Co, Co(OH)₂, CoO, LiₓCoO₂, HₓCoO₂, NaCoO₂, CoₓO₄.

The separator is generally composed of polyolefin fibres (for example polypropylene) or non-woven polyamide.

The electrolyte is a concentrated alkaline aqueous solution comprising at least one hydroxide (KOH, NaOH, LiOH), at a concentration generally of the order of several times normal.

In standard fashion, the electrode pastes are prepared, the electrodes are produced, then at least one cathode, one separator and one anode are placed one upon the other in order to constitute the electrochemical bundle. The electrochemical bundle is introduced into a cup container and impregnated with an aqueous alkaline electrolyte. The accumulator is then sealed.

The invention relates to any accumulator format: prismatic format (flat electrodes) or cylindrical format (spiral or concentric electrodes). The accumulator according to the invention can be of the open (open or semi-open) type or of the sealed type.

### EXAMPLES

Sealed AA-format elements with a capacity of 1100 mAh were produced with an alloy of type AB₅. Table I summarizes the characteristics of the negative electrodes of these elements.

TABLE 1

| series | A | B | C | D | E | F |
|---|---|---|---|---|---|---|
| Nature of magnesium | | Mg(OH)₂ | | | | MgSO₄ |
| compound | | | | | | |
| Mass of this compound/alloy | 0% | 0.1% | 2.7% | 5% | 7% | 2.7% |
| mass | | | | | | |

The negative electrodes were produced as follows: a paste constituted of an aqueous mixture of alloy powder (>98%), CMC (thickening agent, 0.3%), SBR (binder, 1%), carbon (conductor, 0.5%) is pasted in a nickel foam. All the negative electrodes are cut to the same dimensions. The yttrium was added in the form of yttrium oxide at a rate of 0.4% by mass with respect to the mass of hydrogen-fixing alloy. The magnesium is added in the form of hydroxide: Mg(OH)₂ or in the form of MgSO₄.

The positive electrode is a standard foam electrode containing a nickel-based hydroxide and a conductive compound Co(OH)₂.

The bundle constituted of the positive electrode, the non-woven polyolefin separator and the negative electrode is spirally wound and introduced into the cup. The connector elements are then fitted. The cup is filled with 8N electrolyte KOH (6.5N), NaOH (1N), LiOH (0.5N).

The elements first pass through 3 cycles (charge 16 h 110 mA, rest 1 h, discharge 220 mA, cut-off 0.9V). Then the capacity is discharged to C/5, cut-off 0.9V, and measured after a 16 h charge at 110 mA and 7 days' rest at 40° C. This measurement makes it possible to calculate a self-discharge percentage equal to SD=(D₀-D_{7days})/D₀×100 where D_{7days} represents the capacity discharged after 7 days' rest at 40° C. and D₀ the capacity discharged without this rest period. The initial self-discharge percentages are shown in table 2.

TABLE 2

| series | A | B | C | D | E | F |
|---|---|---|---|---|---|---|
| SD (%) | 26% | 26% | 22% | 20% | 19% | 23% |
| % residual capacity after 6 | | | | | | |
| months' overload at 70° C. to | 78% | 79% | 77% | 75% | 32% | 77% |
| C/20 | | | | | | |

These AA-format elements are then subjected to an overload at 70° C. to C/20 for 6 months. At the end of the 6 months' overload at 70° C., the following reference cycle is measured again (charge 16 h 110 mA, rest 1 h, discharge 220 mA, cut-off 0.9V) and compared with the value initially measured (table 2).

The reference accumulator is accumulator A which does not contain the magnesium compound. According to the results presented in table 2, the use of Mg(OH)₂ in the negative electrode hydride paste has a beneficial impact on the initial self-discharge because the self-discharge reduces the reference value of 26% to a value of 19% for a magnesium quantity of 7%. A content of the order of 0.1% magnesium compound is not sufficient to quench the nitrogen because accumulator B displays a self-discharge value of 26%, identical to the reference value. Too high a percentage of magnesium compound, i.e. greater than 5%, shortens the life of the accumulator.

The accumulator according to the invention can be overloaded for an extended period (several months) at high temperature without experiencing significant loss of residual capacity.

1. Composition comprising:
a) a hydrogen-fixing alloy of formula ABₓ where:
A is an element chosen from the group comprising La, Ce, Nd, Pr and Mg, or a mixture of these;
B is an element chosen from the group comprising Ni, Mn, Fe, Al, Co, Cu, Zr, Sn, or a mixture of these;
x is from 3 to 6;
b) a magnesium compound in such a proportion that its mass is greater than 0.1% and less than or equal to 5% of the mass of the hydrogen-fixing alloy.

2. Composition according to claim 1, in which the alloy is chosen from the group comprising alloys of the type AB₅, A₅B₁₉ and A₂B₇.

3. Composition according to claim 1, in which the mass of the magnesium compound is from 1 to 4% of the mass of the hydrogen-fixing alloy, preferably from 2 to 4% of the mass of the hydrogen-fixing alloy.

4. Composition according to claim 1, in which the magnesium compound is chosen from the group comprising Mg(OH)₂, MgSO₄, MgO and Mg₃(PO₄)₂.

5. Composition according to claim 1, containing an yttrium compound.

6. Composition according to claim 5, in which the yttrium mass represents from 0.1% to 2% of the mass of the hydrogen-fixing alloy, preferably more than 0.2% to 1% of the mass of the hydrogen-fixing alloy.

7. Electrode containing the composition according to claim 1.

8. Accumulator containing at least one electrode according to claim 7.

9. Method of producing an electrode according to claim 7, comprising the stages:
a) providing a hydrogen-fixing alloy of formula ABₓ, where:
A is an element chosen from the group comprising La, Ce, Nd, Pr and Mg, or a mixture of these;
B is an element chosen from the group comprising Ni, Mn, Fe, Al, Co, Cu, Zr, Sn, or a mixture of these;
x is from 3 to 6;
b) providing a magnesium compound in such a proportion that its mass is greater than 0.1% and less than or equal to 5% of the mass of the hydrogen-fixing alloy;
c) preparing an aqueous mixture comprising the alloy and compound with the magnesium in order to form a paste;
d) depositing the paste obtained in stage c) on a support.
